(19) United States
(12) Patent Application Publication
(10) Pub. No.: US 2013/0039694 A1
(43) Pub. Date: Feb. 14, 2013

(54) COMPONENT FOR A MOTOR VEHICLE

(71) Applicant: Thomas Hampel, Ingolstadt (DE)

(72) Inventor: Thomas Hampel, Ingolstadt (DE)

(73) Assignee: AUDI AG, Ingolstadt (DE)

(21) Appl. No.: 13/643,258

(22) PCT Filed: Apr. 27, 2011
(86) PCT No.: PCT/EP2011/002108

§ 371 Date: Oct. 24, 2012

(30) Foreign Application Priority Data
Apr. 28, 2010 (DE) 10 2010 018 622.8

(51) Int. Cl. F16B 21/06

(52) U.S. Cl. 403/299; 403/326

(57) ABSTRACT

A component for a motor vehicle includes a wall section and retaining legs which can be elastically spread apart from each other and which are rigidly connected to the wall section. A recess is located intermediate between the retaining legs, wherein a predetermined fastening element can be inserted and anchored in the recess at least when the retaining legs are defective or are at least partially missing.

The invention relates to a component for a motor vehicle with a wall section and with retaining legs that can be elastically spread apart and are fixedly connected to the wall section.

It is customary to produce components for motor vehicles, such as intake manifold for engines, from plastic. Frequently, other motor vehicle components, such as hoses, cables and sensors must be attached easily and securely to these components. This is usually done with clip connections, wherein the clips or clip legs are molded on this component. Although the one-piece construction of the component with the clip legs by injection molding is inexpensive, it has the disadvantage that a broken clip leg can not be easily replaced. It is then customary to replace the entire component, even though the defect is minimal and could be remedied by a new clip leg. An exchange of the entire component is not always the most economical solution.

A fastening element which can be secured in an opening with an internal thread is known from DE 101 46 565 A1. The fastening element is hereby formed with a cylindrical shaft, which has radially encompassing collars. The fastening element thus has, in a longitudinal sectional view, a fir tree profile which causes its dowel-like anchoring in the opening.

A retaining device for filamentary objects is known from DE 198 52 307 A1. Lines, cables, wires, etc. are fixed in the retaining device in a U-shaped shell provided with a spreadable dowel by wrapping the open side of the shell with an elastic band. The entire retaining device is used for mounting the strand-like objects on a motor vehicle body.

It is an object of the invention to provide a component in which defective retaining legs can be replaced easily and inexpensively.

This object is attained with a component having the features of claim 1.

A component according to the invention has a wall section, on which retaining legs are fixedly attached. The wall section may be an inner wall or an outer wall of the component. The wall section may have any shape; in particular, it need not be flat, but may also be curved. The retaining legs fixedly connected to the wall section can be elastically spread apart, i.e., they can deform under an appropriate force such that their spacing increases at least in sections. If no force is applied, then the retaining legs are able to return to their starting position or to assume again their original shape. The component according to the invention further includes a recess which is formed in the space between the retaining legs and which is configured for insertion of a predetermined fastening element. This fastening element can be anchored in the recess at least when the retaining legs are either defective and/or are at least partially missing. In particular, the retaining legs are defective, when they can no longer be moved elastically. They are at least partially missing when pieces are broken off or do otherwise no longer exists. The recess is located in a space between the retaining legs and may be formed in the wall section, for example, by an opening, a recess or a hole. A predetermined fastening element is preferably formed complementary to the recess. If the recess is, for example, a cylindrical hole, then an element having a cylindrical shaft with a diameter smaller than or equal to the diameter of the cylindrical recess is suitable as a predetermined fastening element. The fastening element can then be inserted into the recess and anchored if it cannot be removed from the recess in at least one spatial direction. Retaining legs are components that are capable of holding another component captive or prevent the other component from assuming a different position. In particular, the retaining legs may be formed as so-called clip legs configured to produce a clip connection.

With the recess provided for a predetermined fasting element, the retaining function can also be assumed by the fastening element when retaining legs are defective or missing. If the retaining legs are defective or broken off, then the recess can be accessed by the fastening element so that the fastening element may be able to replace the defective retaining leg. The fastening element then forms a spare part. For this purpose, retaining elements which are equivalent to the retaining legs and are able to at least partially assume the function of the defective retaining legs are preferably attached on the fastening element. The provided recess thus makes it possible to easily and cost-effectively replace defective retaining legs.

When the component and the retaining legs are made in one piece, the entire component must no longer be replaced, in particular when retaining legs are broken off. Instead, for example, a spare clip which assumes the function of the defective retaining leg may be mounted in the provided recess. Optionally, the recess may be machined in an additional step in order to facilitate or to improve anchoring of the fastening element; for example, a thread may subsequently be cut in the recess. The component according to the invention thus provides an uncomplicated and economical solution for spare parts.

The recess may have any shape as long as a predetermined fastening element can be inserted and anchored therein. However, the recess is preferably provided by an element that is different from the retaining legs and the wall section. The solution proposed for the repair element is then independent of the support legs and the wall section. A defective or broken-off retaining leg will then affect the function of the element not at all or only slightly, still leaving the option for a repair solution. A structural boundary between, on one hand, the element and, on the other hand, the wall section moreover makes it possible to simply add the element with the recess on any wall section. An element different from a wall section is, for example, placed on the wall section and/or penetrates into the wall section.

Furthermore, the element with the recess is preferably designed as one piece with the wall section. Additionally or alternatively, the element and the retaining legs can be designed as one piece. This embodiment of the device is robust and very easy to manufacture. With a one-piece design of the element and the wall section, the element is securely affixed on the wall section. If, for example, the retaining legs are lost and the repair solution is used, the fastening element can be attached on the wall section with nearly equivalent strength. An embodiment where all three structural components, namely the element, the retaining leg and the wall section are formed as one piece, can be particularly inexpensively and easily manufactured. When the element is connected with the wall section and/or the retaining legs in a one-piece embodiment, in particular additional fixing aids, such as adhesives, screws, rivets, etc. can be eliminated.

In a particularly preferred embodiment, the element may be formed on the wall section and/or on the retaining legs as a molded sprue, for example produced by injection molding or with an injection molding technique. The technique of injection molding is particularly economical and very precise for mass-produced plastic parts. A particularly rigid connection of the element with the wall section and with the retaining legs is guaranteed. Preferably, the entire component with the retaining legs, the wall section and the element is made as one piece by injection molding. The advantage of this component is then particularly evident. Defective or broken-off retaining legs are difficult to replace. In this case, the provided recess is available to anchor an external fastening element, such as a clip, and to thus provide an alternative solution for the broken-off retaining leg.

Preferably, the element may have an internal thread. Such internal thread enables the predetermined fastening element to be anchored in the recess in a particularly simple manner. For example, the predetermined fastening element may be provided with an external thread, which is complementary to the internal thread of the element. The fastening element can then be screwed into the recess. Alternatively, secure anchoring can be attained by inserting a dowel-shaped fastener with fir tree profile, as known for example from DE 101 46 565 A1.

Furthermore, the element may be made from an elastomeric material, such as a plastic material. A plastic product is not only very inexpensive, but also well suited for manufacture by injection molding. Since the retaining legs must be configured so that they can be spread apart elastically, an elastic plastic material is particularly suited as a material. The element disposed between the retaining legs can then also be easily and readily manufactured from the same plastic material.

Furthermore, the element is preferably formed as a tubular extension. A tubular extension is characterized, on one hand, by a circumferentially closed cross-sectional contour; on the other hand, a tubular extension has an opening with a volume that is large in relation to the volume of the pipe wall. A tubular extension is therefore an element that provides an inner wall with a relatively large area. This makes it particularly easy to anchor the predetermined fastening element in the recess bounded by the inner wall. Moreover, a tubular extension, for example in the form of a slug with bore, can be easily technically realized.

Preferably, the recess of the component is at least partially delimited by a circular cross-sectional contour, for example, when the recess is at least partially formed by a cylindrical opening. Cylindrical openings can be technically easily realized, e.g. by way of a borehole. Since external fastening elements typically also include shafts or pins having a circular cross-section, these external fastening elements can be particularly easily anchored in a circular recess. Moreover, the diameter of a circular cross-sectional contour can also be relatively easily varied.

The component is preferably a tube installed in a motor vehicle. Such a tube may be, for example, an intake manifold of an engine. Different sensors and wires are typically attached on such intake manifold by clip connections. Because clip legs can break off relatively easily, which would require replacement of the entire intake manifold, recesses for clip elements to be alternatively applied can be particularly advantageously provided.

Further advantages, features and details of the invention will become apparent from the following description of a preferred exemplary embodiment and with reference to the drawings. The features and feature combinations mentioned above in the description and the features and feature combinations mentioned below in the description of the drawings and/or the features and feature combinations shown solely in the figures can be used not only in the respective described combination, but also in other combinations or in isolation, without deviating from the scope of the invention.

The invention will now be described in more detail with reference to exemplary embodiments, wherein:

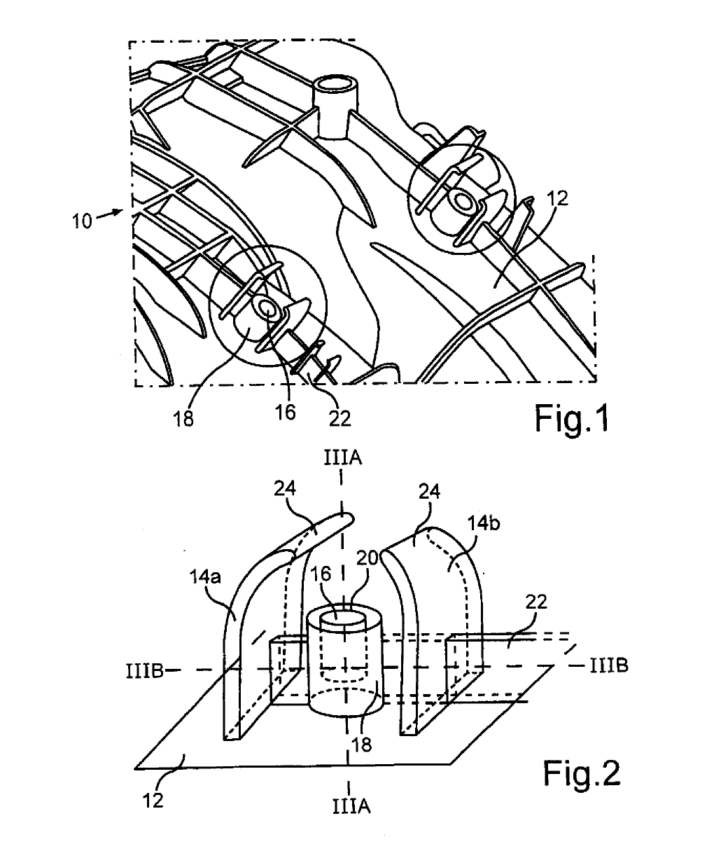

FIG. 1 shows a perspective view of an intake manifold for a motor vehicle as an embodiment of an inventive component;

FIG. 2 shows a perspective view of a detail of an inventive component having two retaining legs, and an intermediate tubular extension;

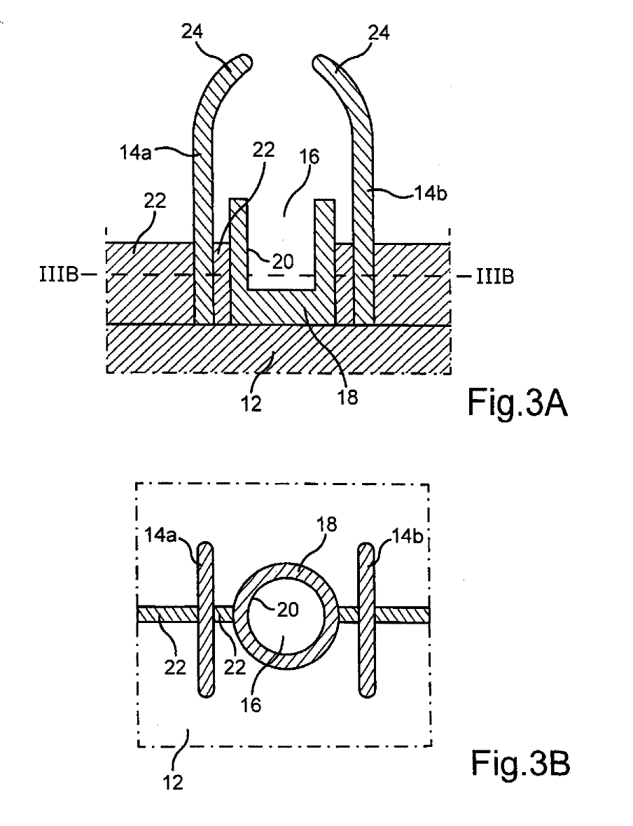

FIG. 3A shows a sectional view of the component of FIG. 2 taken along the line IIIA-IIIA in FIG. 2; and

FIG. 3B shows a schematic sectional view of the component of FIG. 2 taken along the line IIIB-IIIB in FIG. 2.

In the figures, identical or functionally equivalent elements are indicated with identical reference symbols.

FIG. 1 shows an intake manifold 10, as used in motor vehicles. The intake manifold 10 is delimited by a wall section 12 on which a plurality of functional and shape-producing elements are mounted. Retaining legs 14a and 14b and a tubular extension 18 with a circular recess 16 mounted between the retaining legs 14a and 14b is depicted inside the areas indicated by two circles. The retaining legs 14a, 14b as well as the tubular extension 18 are mounted symmetrically with respect to a rail 22 extending on the wall section 12 of the intake manifold.

The retaining legs 14a and 14b in the exemplary embodiment are so-called clip legs which are provided for connecting and affixing other components, such as sensors or a fuel supply line, to the intake manifold 10. A recess 16 is formed between the two clip or retaining legs 14a and 14b by the borehole of a slug. The slug with borehole forms the tubular extension 18. In the exemplary embodiment, the intake manifold 10 is made from plastic, wherein in particular the wall section 12 and the attached elements, such as the retaining legs 14a, 14b, the tubular extension 18 and the rail 22 are made from this material. The retaining legs 14a, 14b and the tubular extension 18 are molded onto the wall section 12, allowing the intake manifold 10 to be produced particularly easily and inexpensively.

FIG. 2 shows a detail of the component of FIG. 1 in a three dimensional view. Corresponding sectional views taken along the lines IIIA-IIIA and IIIB-IIIB are shown in the respective FIGS. 3A and 3B.

The retaining legs 14a, 14b are fixedly connected to the wall section 12. For sake of simplicity, the wall section 12 in the exemplary embodiment is shown as a flat plane. However, the wall section 12 can in principle have any desired shape or curvature. The retaining leg 14a, 14b and the wall section 12 are made by injection molding or an injection molding process as one piece from plastic. It is thereby also ensured that the retaining legs 14a, 14b are elastically movable, as most plastics have very good elastic properties.

In the exemplary embodiment, two retaining legs 14a and 14b are provided, which have at least in a partial section a rectangular longitudinal cross-section (FIG. 3A). Curved end regions 24 extend from the respective rectangular section. In this way, a conventional clip connection can be produced. When a component, such as a pipe, is inserted between the support legs 14a and 14b in the direction towards the wall section 12, the support legs 14a and 14b are able to elastically move away from each other, so that the component can enter the space between them. The elastic retaining legs 14a, 14b then return to their original position and thus fix the component in place. As an alternative to the illustrated embodiment, more than two retaining legs may be present, which need not be constructed identically. The contours of the retaining legs 14a, 14b may also have an arbitrary cross-section as long as a clip connection can be created. The retaining legs 14a, 14b may be made from a material other than plastic, for example from sheet metal.

A recess 16 is located intermediate between the retaining legs 14a and 14b. At least one predetermined fastening member can be inserted and anchored in the recess 16 when the retaining legs 14a, 14b are defective or are at least partially missing. In the exemplary embodiment of the FIGS. 2, 3A and 3B, this recess 16 is provided by an element, namely a tubular extension 18, which is different from the retaining legs 14a, 14b and the wall section 12. The tubular extension 18 is made from plastic and is connected to the wall section 12 by injection molding. The tubular extension 18 is cylindrical and rotationally symmetrical with respect to a vertical axis that is oriented vertically on the wall section 12. Its recess 16 is also cylindrical. The cylindrical recess 16 and the cylindrical tubular extension 18 are centered relative to one another, or have the same cylinder axis or axis of rotation. The depth of the cylindrical recess 16 in the axial direction is less than the height of the cylindrical tubular extension 18 in the axial direction. Due to the recess 16, the tubular extension 18 has an inner wall 20 which is smooth in the exemplary embodiment.

Other unillustrated embodiments of the recess 16 disposed between the retaining legs 14a, 14b are possible. For example, the tubular extension 18 may be completely omitted, resulting in a recess between the retaining legs 14a and 14b in the wall section 12. The recess 16 would then be an opening, a hole or a depression in the wall section 12. The recess 16 could then once more have, for example, a circular cross-section and be provided with an internal thread. The recess 16 may be implemented in form of a through-hole or a blind hole. The recess 16 may also be provided by an element that is different from the retaining legs 14a, 14b and the wall section 12, but shares constructive areas therewith. For example, the retaining legs 14a, 14b may transition smoothly into the wall of the tubular extension 18, or the inner wall 20 of the tubular extension 18 may be at least partially formed by the retaining legs 14a, 14b. It may also be possible that the tubular extension 18 and the wall section 12 are not directly connected with one another, but that the tubular extension 18 is instead attached on the retaining legs 14a, 14b.

The essential advantage of this component is obtained when the retaining legs 14a, 14b suffer brittle fracture due to, for example, frequent elastic deformations, and thus become defective or break off. They are then no longer available for additional clip connections and need to be replaced. However, this is no longer possible when the retaining legs 14a, 14b are integrally formed with the wall section 12, in which case, for example, the entire intake manifold 10 must be replaced. The tubular extension 18 with the recess 16 is provided as an economical solution. A predetermined fastener, which can then replace, for example, the missing retaining legs 14 14b, can be inserted and anchored in the tubular extension 18.

For example, such fastening element may have a shaft with a fir tree profile or with an external thread and can thus be fixed in the recess 16 of the tubular extension 18 like a dowel or by screwing. The fastening element is prevented by the inner wall 20 from moving laterally following insertion into the recess 16 of the tubular extension 18 parallel to the cylinder axis. The fastening element can be fixed in the axial direction by proven designs, for example with a thread, with spreaders, retaining hooks and the like. For example, retaining legs identical to the retaining legs 14a, 14b can then be attached on the shaft, replacing the retaining legs 14a and 14b. In the exemplary embodiment, the inner wall 20 of the tubular extension 18 is constructed so that a thread can later be cut for improving anchoring of the fastening element.

1.-9. (canceled)

10. A component for a motor vehicle, comprising:
a wall section,
a plurality of retaining legs connected to the wall section and constructed to be elastically spread apart, and
a recess disposed intermediate between the retaining legs and configured for insertion and anchoring therein of a predetermined fastening element when the retaining legs are defective or are at least partially missing.

11. The component of claim 10, further comprising an element which is different from the retaining legs and the wall section, wherein the recess is disposed in the element.

12. The component of claim 11, wherein the element and at least one of the wall section and the retaining legs are formed as one piece.

13. The component of claim 11, wherein the element is formed as a sprue that is integrally molded on at least one of the wall section and on the retaining legs.

14. The component of claim 11, wherein the element has an internal thread.

15. The component of the claim 11, wherein the element is made from an elastomeric material.

16. The component of claim 11, wherein the element is a pipe socket.

17. The component of claim 10, wherein the recess is at least partially delimited by a circular cross-sectional contour.

18. The component of claim 10, wherein the component is formed as a tube.
